(19) United States
(12) Patent Application Publication
(10) Pub. No.: US 2012/0130013 A1
(43) Pub. Date: May 24, 2012

(54) Method For Producing Epoxide Amine Addition Compounds

(76) Inventors: Jörg Issberner, Willich-Neersen (DE); Frank Tlauka, Oberhausen (DE); Tom Beckmann, Duisburg (DE); Ulrich Orth, Wesel (DE); Jürgen Omeis, Dorsten-Lembeck (DE)

(21) Appl. No.: 13/321,028

(22) PCT Filed: May 4, 2010
(86) PCT No.: PCT/EP10/02712

§ 371 Date: Dec. 22, 2011

(30) Foreign Application Priority Data
May 20, 2009 (DE) 10 2009 022 148.4

(51) Int. Cl. C08G 59/02; C08L 75/12; C08G 18/58

(52) U.S. Cl. 524/590; 528/407; 528/68

(57) ABSTRACT

The present invention relates to a method for the production of addition compounds by converting an epoxide component (A) comprising at least two epoxide functions with at least one amine component (B) comprising a primary amine function in a continuous operation in a reactor, with the epoxide component (A) and the amine component (B) being continuously supplied in a molar ratio from 5:1 to 1:50 such that in the reactor a reaction mixture product develops comprising the epoxide component (A) and the amine component (B), as well as the conversion products from the epoxide component (A) and the amine component (B), which is drained from the reactor in the form of a product flow, with 10-100 mol % of the epoxy functions introduced into the reactor via the epoxide component (A) being converted in the reactor. The addition compounds yielded are preferably used as cross-linking and dispersing agents.

The invention relates to a method for producing addition compounds, these addition compounds, a urethane compound, the use of the urethane compound, as well as powdered or fibrous solid substances.

Cross-linking or dispersing means are used as additives particularly for the production of pigment concentrates as well as the stabilization of solid substances in binders, enamels, plastics, and plastic mixtures. Considerable objectives of such additives are particularly the reduction of viscosity, the improvement of storage stability, as well as the flow features and perhaps the increase of the color intensity (when pigments are included). High mechanic forces are required to stably introduce solid materials into liquid media. Thus, it is common to use means to lower the dispersing forces and thus to keep both the necessary overall energy input into the system as well as the dispersing period as low as possible. The known dispersing means usually represent surface-active substances, which are added in small amounts either directly to the solid substance or into the liquid medium. Particularly the compounds of the polyepoxy/amine type are considered cross-linking and dispersing means proven in practice.

DD-C 154 985 relates to a production method, performed discontinuously, of high-molecular (molecular weight >10,000 g/mol) polyepoxide/amine adducts, in which the respective epoxide component including aromatic diglycide ethers are used. In these production processes long reaction periods (partially up to 60 seconds) as well as partially yellow and/or brownish coloration of the reaction products yielded are disadvantageous.

DE-A 10 2007 005 70 describes highly effective cross-linking and dispersing means of the polyepoxide/amine type, which are present as copolymers yielded by way of polyaddition and which are produced in a two-stage conversion process. In the first stage polyepoxide/amine adducts are made from the respective polyepoxides and amines, with in the second stage the polyepoxide/amine adducts produced in the first stage are converted with isocyanates modified by polyaclylene oxides. However, in large-scale applications the reaction underlying the first stage can be controlled only with an extremely high (safety) expense because said reaction is extremely exothermal as well as hard to control (at low temperatures due to the low reactivity there is additionally the risk for accumulation of crude material and at high temperatures the reactivity is particularly high). The quality of the appropriate copolymers used as cross-linking and dispersing agents (reaction products of the second stage) must be considered good, though. The urethane bonding present in the copolymer allows both a wide tolerance of common binder-solvent systems as well as an advantageous long-term and storage stability due to its chemical inertness. However, there is still the desire to further improve the quality of the polyepoxide/amine adducts present as preliminary products and/or the copolymers present as the final product.

Therefore, the objective of the present invention is to provide an economical and safe method for producing a polyepoxide/amine adduct, based on which high-quality cross-linking and dispersing agents can be produced.

This objective is attained in a method for the production of the addition compounds by converting
a) an epoxide component (A) comprising at least two epoxide functions with
b) at least one amine component (B) comprising a primary amine function
   in a continuous operating manner in a reactor, with the epoxide component (A) and the amine component (B) being added continuously in a molar ratio from 5:1 to 1:50 such that in the reactor a reaction mixture develops comprising the epoxide component (A), the amine component (B), as well as the conversion products from the epoxide component (A) and the amine component (B), which is drained from the reactor in the form of a product flow, with 10-100 mol % of the epoxide functions introduced into the reactor by the supply of the epoxide component (A) are converted in said reactor.

The conversion products from the epoxide component (A) and the amine component (B) are preferably provided in the form of addition compounds. The fact that 10-100 mol % of the epoxide functions introduced by the supply of the epoxide component (A) into the reactor are converted in said reactor means that a minimum portion of the epoxide component (A) continuously introduced into the reactor primarily (or perhaps exclusively) reacts with the amine component (B) as well as the already produced addition compounds (conversion products from the epoxide component (A) and the amine component (B)) in the reactor itself. Here, the method according to the invention ensures that the reaction mixture remains sufficiently long inside the reactor.

The method according to the invention ensures the production of addition compounds, which show a particularly uniform and high quality. In this context, the relatively close distribution of molecular weights of the addition compounds yielded as well as the relatively low portion of byproducts must be particularly emphasized. It is also essential that the method according to the invention can be handled relatively easily, allowing a good control of the underlying extremely exothermal reaction. Particularly in permanent operation the method according to the invention ensures high economic efficiency.

Compounds are used as epoxide components (A) which comprise two or more epoxide groups per molecule and normally show at least six carbon atoms. Although not excluded, except for epoxide functions, the latter compounds generally include no other additional functional groups. The epoxide component (A) can also be present as a mixture of various compound species.

Generally, a diepoxide with the general formula I is used as the epoxide component (A),

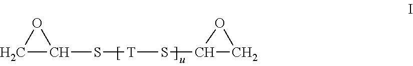

with
S being identical or different and representing CH₂—O or CH₂,
T being identical or different and representing branched or un-branched C₂-C₁₈-alkylene, C₅-C₁₂-cycloalkylene, C₆-C₁₀-arylene, or branched or un-branched C₆-C₁₅ aralkylene, and
u representing an integer from 1 to 8.

Typical examples for species used as epoxide components (A) are conversion products of diphenylol propane (biphenol A) and epichlorohydrin as well as their higher homologues (offered for example under the trade name D.E.R. or Epikote by DOW Chemical Company and/or Resolution Performance Products), 1.6-hexanediglycidyl ether, 1.4-butandiglycidyl ether, polypropylene glycol glycidyl ether, and polytetrahydrofurane diglycidyl ether (available under the trade name Grilonit® of Ems-Chemie).

Compounds are used as the amine component (B) having at least one primary amino function, which preferably comprise 3 to 28 carbon atoms and perhaps show additional functional groups, which usually are present in the form of hydroxyl groups or tertiary amino groups, however preferably not as alkoxy functions.

The amine component (B) can also be present as a mixture of different compound species. Preferably the amine components (B) are selected from primary amines with the general formula II

H₂N—R II

with
R representing branched or un-branched C₃-C₁₈-alkyl, C₅-C₁₂-cycloalkyl, C₆-C₁₀-aryl, or branched or un-branched C₇-C₁₂-aralkyl
and/or primary amines with the general formula III

H₂N—R′—Z III

with
R′ representing a branched or un-branched C₂-C₁₂-alkylene group and
Z representing an aliphatic or aromatic heterocyclic C₃-C₆-moiety.

Typical examples for species that can be used as amine components (B) are ethanolamine, butanolamine, dimethylaminopropylamine, 2-amino-2-methyl-1-propanol, amines with more than only one additional functional group, such as amino-2-ethyl-1,3-propandiol, or 2-amino-2-hydroxymethyl-1,3-propandiol, with the use of ethanolamine, butanolamine, and/or dimethylaminopropylamine being particularly preferred.

The conversion of the epoxide component (A) with the amine component (B), which occurs under the formation of a β-hydroxy amino function, can be performed in a solvent system,

however preferably in a method using a substance produced according to method known to one trained in the art. Here, the reaction temperature to be selected also depends on the reactivity of the educts. Many epoxides already react with amines at room temperature. However, for some few epoxides considerably higher reaction temperatures may be required. If applicable, one trained in the art may use known catalysts in order to accelerate the conversion of the epoxide with the amine.

Usually, the epoxide component (A) and the amine component (B) are continuously supplied to the reactor in a molar ratio from 2:1 to 1:5, preferably from 1:1 to 1:1.5.

Commonly 25-100 mol %, preferably 50-95 mol % of the epoxide functions in the reactor is converted, introduced by the supply of epoxide components (A) into the reactor.

In a preferred embodiment of the invention the temperature of the reaction mixture in the reactor amounts to 50-180° C., preferably 80-130° C., as well as particularly preferred 95-120° C., with then the quotient from the overall volume of the reaction mixture contained in the reactor and the overall volume flow of the reaction mixture drained from the reactor in the form of a product flow amounting to 2-20,000 seconds, preferably 5-10,000 seconds, particularly preferred 10-5,000 seconds.

The quotient from overall volume of the reaction mixture contained in the reactor and the overall volume flow of the reaction mixture drained from the reactor in the form of a product flow must be considered a measure for the exposure period. The relevant, comparatively short exposure periods ensure that in spite of the relatively high temperatures any undesired secondary reactions show only minor effects.

The epoxide component (A) and the amine component (B) are each normally supplied to the reactor at an entry temperature from −20 to 200° C., preferably from 0 to 150° C., particularly preferred from 25 to 100° C. The difference between the outlet temperature (when leaving the reactor) of the reaction mixture and said entry temperature usually amounts from 0 to 200° C., preferably from 10 to 100° C. Typically the heating power in reference to the heat supplied from the outside into the reaction mixture in the rector ranges from 5 to 1500 Watt per kg, preferably approximately 1000 Watt per kg. Usually the overall volume of the reaction mixture contained in the reactor ranges from 0.001 to 100 liters, preferably from 0.05 to 10 liters, particularly preferred 0.05 to 5 liters.

In a preferred embodiment the reactor is equipped with mobile elements, which by the supply of mixing energy cause the mixing in a dynamic fashion in the reactor. The dynamic mixing leads to the creation of a particularly homogenous reaction mixture as well as an effective provision of reaction heat in favor of a stable reaction temperature.

Particularly preferred the reactor is embodied in the form of a proportioning reaction pump, comprising a rotating container which accepts the epoxide component (A) and the amine component (B) separated from each other and brings these two components in contact with each other under the influence of mechanical shearing and mixes them. The rotating container is frequently embodied in the form of a channel system (which is formed in an appropriate rotary body) and is commonly surrounded by a stationary jacket, with gaps developing between the jacket and the rotating container filled with the reaction mixture. Commonly the mechanical shearing occurs both within the channel system as well as in these gaps. DE-C 42 20 239 describes such a proportioning reaction pump, particularly well-suited for the execution of the method according to the invention. Said pump essentially comprises a rotary-symmetrical mixing chamber, which is formed by a circumferential wall and two facial walls and an agitating rotor arranged in the mixing chamber, driven by a rotary magnet. The agitating rotor comprises at its circumference evenly distributed chamfers and at its facial walls recesses, which together with the annular channels form pressure cells in the facial walls, with the pressure cells being connected to each other via penetrating bores in the rotor. Further the proportioning reaction pump comprises in the circumferential wall at least one inlet opening for each educt and an outlet opening for the reaction mixture. The pump head can be tempered via a temperature circuit using an external heating and/or cooling aggregate. The periphery comprises at least one, perhaps heated dosing device for each educt and a downstream arranged, perhaps heated conduit for the reaction mixture. The rotary frequency of the rotor, which beneficially is controlled via an external frequency inverter, amounts commonly from 50 to 1000 revolutions per minute when performing the method according to the invention. It has shown that the molecular weight of the addition compounds yielded is nearly independent from the rotary frequency of the rotor.

The above-described proportioning reaction pumps accelerate the substance and thermal transportation processes, allowing the precise adjustment of the starting and framework conditions of the reaction. The exposure periods can be adjusted particularly precisely, in which the strongly exothermal method according to the invention can be operated almost isothermally.

Frequently, additional reactor systems operated continuously are arranged downstream in reference to the reactor, which preferably implement the re-dosage of the epoxide component (A) and/or the amine component (B) and/or a re-tempering. The secondary reaction in the downstream arranged reactor systems frequently ensures ultimately the achievement of the desired conversion, which typically amounts to approx. >95% in reference to the overall convertible epoxide functions.

Typically, the reactor is arranged in a device, which comprises additional reactor installations, operating independently from each other and continuously, in which the epoxide component (A) is converted with the amine component (B), with these reactor installations and the reactor simultaneously and independently from each other being operated parallel. Such a parallel operation ensures not only the creation of high production amounts but also a high flexibility, because a reactor device operated in this manner can be replaced by another one at short notice and with relatively low expenses.

The present invention also relates to addition compounds, which can be produced by the above-described method.

As already stated, these addition compounds are characterized in a particularly uniform and high quality (close distribution of molecular weight as well as relatively low rate of byproducts).

Furthermore, the present invention relates to a urethane compound yielded from the conversion of the above-described addition compounds with at least one isocyanate component with the general formula IVa and/or IVb.

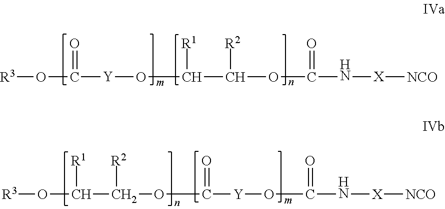

with
R³ representing branched or un-branched C₁-C₁₈-alkyl, C₅-C₁₂-cycloalkyl, C₆-C₁₀-aryl, and/or branched or un-branched C₇-C₁₅-aralkyl,
R¹ and R² being each identical or different and representing independent from each other H, branched or un-branched C₁-C₁₅-alkyl and/or C₆-C₁₀-aryl,
X representing a branched or un-branched C₄-C₁₈-alkylene group, C₆-C₁₂-cycloalkylene group, and/or a branched or un-branched C₆-C₁₀-aralkylene group,
Y being identical or different and representing a branched or un-branched C₄-C₁₇-alkylene group and/or a C₅-C₁₂-cycloalkylene group,
n representing an integer from 0-100, preferably 1-100, particularly preferred 2-100, and
m representing an integer from 0-100, preferably 1-100, particularly preferred 2-100.

In a preferred embodiment the isocyanate component is used in such a stoichiometric ratio in reference to the addition compounds according to the invention that 5-100%, preferably 20-100%, and particularly preferred 40-100% of the OH-groups of the addition compounds are converted under the formation of urethane.

The isocyanate component is preferably produced according to the methods described in DE-A 199 19 482. For this purpose, monohydroxy-compounds with excessive diisocyanate, preferably toluene diisocyanate, are converted and the non-converted part of the diisocyanate is removed from the reaction mixture.

Additionally the present invention relates to the use of the above-described urethane compound as cross-linking and/or dispersing agents for organic and/or inorganic pigments or tillers.

The urethane compound according to the invention is a high-quality and largely tolerated cross-linking and dispersing means, with its quality significantly being determined by its preliminary products in the form of the addition compounds according to the invention. The use as

a cross-linking and/or dispersing agent relates according to the invention to the cross-linking/dispersing of organic and/or inorganic pigments or fillers. The dispersing agents can be used alone or together with binders.

In addition to the use as cross-linking and dispersing agents in aqueous and/or solvent-containing dispersions, particularly enamels, it is also possible to coat powdered or fibrous solid substances with the urethane compounds according to the invention.

Thus, the present invention also relates to powdered or fibrous solid substances coated with the above-described urethane compound.

Such coatings of organic and inorganic solid substances are performed in a manner known per se. For example, such methods are described in EP-A 0 270 126. Particularly in case of pigments, a coating of the pigment surface can occur during or after the synthesis of the pigments, for example by the addition of the urethane compound according to the invention to the pigment suspension. Pigments pretreated in this fashion show an ability for easy integration into the system of binders, an improved viscosity and flocculation behavior, as well as good gloss in reference to untreated pigments. Therefore, the urethane compounds according to the invention are suitable for dispersing e.g., special effects pigments in nail polish.

The urethane compound according to the invention is preferably used in an amount of 0.5-60% by weight in reference to the dispersing solid substances. In particular solid substances considerably higher amounts of dispersing agents may be necessary for dispersing, though.

The amount of dispersing agent used is essentially dependent on the size and type of the surface of the solid substances to be dispersed. For example, soot requires considerably higher amounts of dispersants than titanium-dioxide. In EP-A 0 270 126 examples are shown for pigments and fillers. Additional examples based on new developments, particularly in the field of organic pigments, such as the class of diketo-pyrrolopyrroles. Magnetic pigments based on pure iron or mixed oxides can also be integrated in dispersions with the help of urethane compounds according to the invention. Furthermore, mineral fillers, such as calcium carbonate and calcium oxide or flame-retarding agents such as aluminum or magnesium hydroxide may be dispersed. Additionally, matting agents, such as silica gel are dispersed and stabilized.

In the following the invention shall be described in greater detail using the exemplary embodiments.

### REFERENCE EXAMPLE 1

### Not according to the Invention, without any Solvents

In a 2000 ml four-neck flask with KPG-agitator, nitrogen pipeline, and intensive cooling 435 g benzylamine is provided and heated to 100° C. Subsequently 1065 g 1,6-hexandiglycidyl ether is added in a dosed fashion within 180 min at a constant temperature of 100° C. The tested method therefore occurs at 100% in the substance. The reaction was continued for 120 min at 100° C. The overall energy amounts to −799 kJ/kg (Tad=470K)—however a higher exothermic is given. The required cooling power amounts to 80 W/kg.

### REFERENCE EXAMPLE 2

### Not according to the Invention, with Solvents

In a 2000 ml four-neck flask with KPG-agitator, nitrogen pipeline, and intensive cooling 242 g benzylamine is provided in 726 g butylacetate and heated to 100° C. Subsequently 533 g 1,6-hexandiglycidyl ether is added within 180 min at a constant temperature of 100° C. The reaction was continued for 120 min at 100° C. The accumulated thermal energy at the end of the dosing amounts to 40% though,—i.e. considerable amounts have not reacted.

### EXAMPLE 3

### According to the Invention; without any Solvents

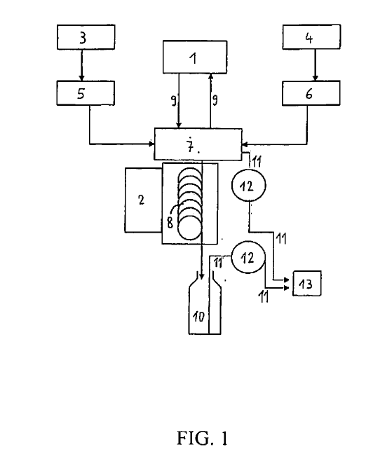

The drawing shows in FIG. 1 the respective test design in a schematic fashion, based on example 3 of the invention.

The thermostats 1 and 2 were adjusted to operating temperatures (thermostat 1=reaction chamber: 140° C.; thermostat 2=continued reaction: 90° C.).

After the thermostats have reached the operating temperatures the mass flows from the reservoirs 3 and 4 (benzylamine: 1,299 g/min; 1,6-hexandiglycidyl ether: 3,174 g/min) via pumps 5 and 6 into the reaction chamber of the proportioning reaction pump 7 is continuously promoted. The proportioning reaction pump was operated via a frequency inverter with 80% of the maximally possible rotation. During the reaction (continuously over min 5 hours) a temperature of 79-98° C. was measured in the reaction chamber of the proportioning reaction pump. For continued reaction the reaction mixture was guided via a suitable hose 8 through a heated bath of the thermostat 2. The hose 8 used (for continued reaction), had an interior diameter of 4 mm and a length of 4 m (overall system volume 155.8 ml). The overall reaction time amounted to 36.1 minutes. Connecting insulated hoses 9 were arranged between the thermostats 1 and the proportioning reaction pump 7. The proportioning reaction pump 7 and an appropriately installed collection container 10 were each connected via data conduits 11 and installations for an analytic collection 12 via a computer 13.

Upon a completed reaction, all pumps were rinsed with suitable solvents. At room temperature a highly viscous, slightly yellowish polymer is yielded with the following analytic data:

Color: colorless to slightly yellowish
Weight: average molecular weight: 3000-4500 g/mol

The method according to the invention according to example 3 is easier and handled more safely in reference to the method according to the reference example 1. The amount of cooling power required per amount of glycidyl ether converted is lower in the method according to the invention as shown in example 3 than the respective cooling power used for the method according to the reference example 1. The processing product underlying example 3 shows a lower viscosity as well as a lower OH-count (hydroxyl groups per weight unit) than the processing product according to the reference example 1. Urethane compounds according to the invention resulting from the conversion of the processing product of example 3 with an appropriate isocyanate component are excellently suited as cross-linking or dispersing agents for pigments or fillers.

1. A method for the production of the addition compounds by converting
a) an epoxide component (A) comprising at least two epoxide functions with
b) at least one amine component (B) comprising a primary amine function
in a continuous operating manner in a reactor, with the epoxide component (A) and the amine component (B) being added continuously in a molar ratio from 5:1 to 1:50 such that in the reactor a reaction mixture develops comprising the epoxide component (A), the amine component (B), as well as the conversion products from the epoxide component (A) and the amine component (B), which is drained from the reactor in the form of a product flow, with 10-100 mol % of the epoxide functions introduced by the supply of the epoxide component (A) into the reactor are converted in said reactor.

2. A method according to claim 1, characterized in that a diepoxide with the general formula I is used as the epoxide component (A), 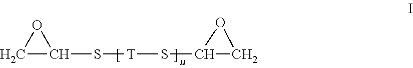
with
S being identical or different and representing CH₂—O or CH₂,
T being identical or different and representing branched or un-branched C₂-C₁₈-alkylene, C₅-C₁₂-cycloalkylene, C₆-C₁₀-arylene, or branched or un-branched C₆-C₁₅ aralkylene, and
u representing an integer from 1 to 8.

3. A method according to claim 1 or 2, characterized in that the amine component (B) is selected from primary amines with the general formula II
H₂N—R II
with
R representing branched or un-branched C₃-C₁₈-alkyl, C₅-C₁₂-cycloalkyl, C₆-C₁₀-aryl, or branched or un-branched C₇-C₁₂-aralkyl
and/or primary amines with the general formula III
H₂N—R′—Z III
with
R′ representing a branched or un-branched C₂-C₁₂-alkylene group and
Z representing an aliphatic or aromatic heterocyclic C₃-C₆-moiety.

4. A method according to one of claims 1 through 3, characterized in that the epoxide component (A) and the amine component (B) are continuously supplied to the reactor in a molar ratio from 2:1 to 1:5, preferably from 1:1 to 1:1.5.

5. A method according to claim 4, characterized in that 25-100 mol %, preferably 50-95 mol % of the epoxide functions introduced into the reactor by the supply of the epoxy component (A) is converted in the reactor.

6. A method according to one of claims 1 through 5, characterized in that the temperature of the reaction mixture in the reactor amounts to 50-180° C., preferably 80-130° C., and particularly preferred 95-120° C., with the quotient of the overall volume of the reaction mixture contained in the reactor and the overall volume flow of the reaction mixture drained from the reactor in the form of a product flow amounts to 2-20,000 seconds, preferably 5-10,000 seconds, particularly preferred 10-5,000 seconds.

7. A method according to one of claims 1 through 6, characterized in that the overall volume of the reaction mixture contained in the reactor amounts to 0.001-100 liters, preferably 0.05-10 liters, particularly preferred 0.05-5 liters.

8. A method according to one of claims 1 through 7, characterized in that the reactor is equipped with mobile elements, which perform mixing functions in the reactor in a dynamic fashion by adding mixing energy.

9. A method according to one of claims 1 through 8, characterized in that the reactor is embodied in the form of a proportioning reaction pump comprising a rotating container, which accepts the epoxide component (A) and the amine component (B) separated from each other and brings these components in contact with each other under the influence of mechanical shearing and mixes them.

10. A method according to one of claims 1 through 9, characterized in that additional reactor systems, operated continuously, are arranged downstream in reference to the reactor, which preferably implement a re-dosing of the epoxide component (A) and/or the amine component (B) and/or a re-tempering.

11. A method according to one of claims 1-10, characterized in that the reactor is arranged in a device, which comprises additional reactor installations each operating independent from each other and continuously, in which the epoxide component (A) is converted with the amine component (B), with these reactor installations and the reactor being operated parallel, simultaneously, and independently from each other.

12. Addition components that can be produced according to the method according to one of claims 1-11.

13. A urethane compound yielded from the conversion of addition compounds according to claim 12 with at least one isocyanate component with the general formula IVa and/or IVb. 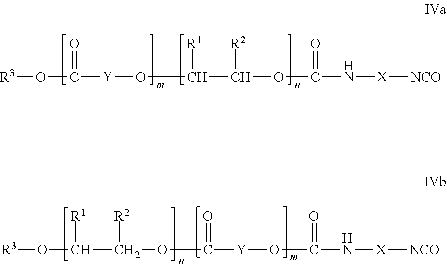
with
R³ representing branched or un-branched C₁-C₁₈-alkyl, C₅-C₁₂-cycloalkyl, C₆-C₁₀-aryl, and/or branched or un-branched C₇-C₁₅-aralkyl,
R¹ and R² each being identical or different and representing independent from each other H, branched or un-branched C₁-C₁₅-alkyl and/or C₆-C₁₀-aryl,
X representing a branched or un-branched C₄-C₁₈-alkylene group, C₆-C₁₂-cycloalkylene group, and/or a branched or un-branched C₆-C₁₀-aralkylene group,
Y being identical or different and representing a branched or un-branched C₄-C₁₇-alkylene group and/or a C₅-C₁₂-cycloalkylene group,
n representing an integer from 0-100, preferably 1-100, particularly preferred 2-100, and
m representing an integer from 0-100, preferably 1-100, particularly preferred 2-100.

14. The use of a urethane compound according to claim 13 as a cross-linking and/or dispersing agent for organic and/or inorganic pigments or fillers.
Powdered or fibrous solid substances, coated with a urethane compound according to claim 13.
